(19) United States
(12) Patent Application Publication
(10) Pub. No.: US 2020/0326700 A1
(43) Pub. Date: Oct. 15, 2020

(54) FRACTIONATED PAYLOAD SYSTEM AND METHOD THEREFOR

(71) Applicant: BENCHMARK ELECTRONICS, INC., TEMPE, AZ (US)

(72) Inventor: JIM LUECKE, TEMPE, AZ (US)

(73) Assignee: BENCHMARK ELECTRONICS, INC., TEMPE, AZ (US)

(21) Appl. No.: 15/930,083

(22) Filed: May 12, 2020

Related U.S. Application Data
(60) Provisional application No. 62/832,531, filed on Apr. 11, 2019.

(51) Int. Cl. G05D 1/00; G06N 20/00; B64C 39/02

(52) U.S. Cl. CPC G05D 1/0022; G05D 1/0027; G05D 1/0094; B64C 2201/146; B64C 39/024; B64C 2201/122; G06N 20/00

(57) ABSTRACT

A payload transport system has a plurality of unmanned aerial vehicles (UAVs). The payload is fractionated into a plurality of components wherein each of the plurality of components is coupled to one of the plurality of UAVs, wherein each of the plurality of components wirelessly communicating to function as the payload.

### RELATED APPLICATIONS

This patent application is related to U.S. Provisional Application No. 62/832,531 filed Apr. 11, 2019, entitled “FRACTIONATED SYSTEMS” in the name of Jim Luecke, and which is incorporated herein by reference in its entirety. The present patent application claims the benefit under 35 U.S.C § 119(e).

### TECHNICAL FIELD

The present application relates generally to the technical field of unmanned platforms, and more specifically, to the technical field of fractionating a payload so that the payload is disintegrated into a set of small elements which may be carried on a plurality of smaller unmanned platforms.

### BACKGROUND

Unmanned aerial vehicles (UAVs) may be any aircraft without a human pilot aboard. These vehicles may be commonly referred to as drones. In general, drones may be flown and controlled either autonomously by onboard computers or by the remote control of a pilot on the ground or in another vehicle. Unmanned aerial vehicles, or drones, were initially developed for military purposes to carry weapons or to conduct surveillance. In recent years, however, use of drones has become increasingly popular for other uses, such as scientific research, surveillance, inspections, non-military security work and other similar applications.

Traditionally, unmanned platforms such as drones and robots have been selected based upon the payload to be carried, often resulting in a larger-than-desired solution. Compared to a small drone, the large platform drone is expensive, lacks covertness and is limited in the missions it may perform due to its very size, as a small drone can go places a big one cannot.

Therefore, it would be desirable to provide a system and method that overcomes the above. The system and method would fractionize or “dis-integrates” a large platform into a cluster or array of smaller platforms wherein the cluster of smaller platforms would function as the single larger platform. The system and method would enable the cluster of smaller platforms to function as the single large platform through appropriate infrastructure and cooperative functionality.

### SUMMARY

In accordance with one embodiment, a payload transport system is disclosed. The payload transport system has a plurality of unmanned aerial vehicles (UAVs). The payload is fractionated into a plurality of components wherein each of the plurality of components is coupled to one of the plurality of UAVs, each of the plurality of components wirelessly in communication to function as the payload.

In accordance with one embodiment, a payload transport system is disclosed. The payload transport system has a plurality of unmanned aerial vehicles (UAVs). The payload is fractionated into a plurality of components wherein each of the plurality of components is coupled to one of the plurality of UAVs. Each of the plurality of components is wirelessly in communication with one another to form a network and to function as the payload. Tasks of at least one of the components is decentralized and distributed between multiple components. Each of the plurality of components comprises a processing, networking, communication interface (PNCI) wirelessly interconnecting the plurality of components to form a cluster network. Each PNCI has a wireless communicating and routing unit transmitting and receiving data signals between the plurality of components, an artificial intelligence/machine learning unit and a processing and storage unit.

### BRIEF DESCRIPTION OF THE DRAWINGS

The present application is further detailed with respect to the following drawings. These figures are not intended to limit the scope of the present application but rather illustrate certain attributes thereof. The same reference numbers will be used throughout the drawings to refer to the same or like parts.

FIG. 1 is an exemplary block diagram depicting a fractionated payload system in accordance with one aspect of the present application;

FIG. 2A is an exemplary block diagram of a wireless node network forming the fractionated payload system of FIG. 1 in accordance with one aspect of the present application;

FIG. 2B is an exemplary block diagram of a wireless node network forming the fractionated payload system of FIG. 1 in accordance with one aspect of the present application; and

FIG. 3 is an exemplary block diagram of a processing, networking, communication interface used in the fractionated payload system of FIG. 1 in accordance with one aspect of the present application.

### DESCRIPTION OF THE APPLICATION

The description set forth below in connection with the appended drawings is intended as a description of presently preferred embodiments of the disclosure and is not intended to represent the only forms in which the present disclosure can be constructed and/or utilized. The description sets forth the functions and the sequence of steps for constructing and operating the disclosure in connection with the illustrated embodiments. It is to be understood, however, that the same or equivalent functions and sequences can be accomplished by different embodiments that are also intended to be encompassed within the spirit and scope of this disclosure.

The present disclosure relates to a system and method that fractionizes or “dis-integrates” a large platform into a cluster or array of smaller platforms wherein the cluster of smaller platforms would function as the same single large platform. To enable the use of smaller platforms, the payload may be fractionated, which is to say, dis-integrated into a set of smaller elements each of which may be carried on a small platform. The resulting cluster of small platforms still performs as a single, more flexible platform, through an appropriate connecting infrastructure—wireless networking, processing, memory and intelligence—and collaborative operation. Moreover, a homogeneous infrastructure attains economy-of-scale, reducing system cost, while improving system reliability, survivability and modularity. With a decentralized and distributed architecture, this infrastructure establishes a multi-function capability wherein tasks and processing can be distributed, shared, even performed as a surrogate for a drone in need of support.

A cluster of smaller platforms may behave differently than a singular large platform, making it amenable to new means of optimizing that behavior. This optimization may utilize artificial intelligence (AI) and machine learning (ML). If established as a distributed and decentralized function, this AI/ML capability can be included as a core, and even become the core, of the cluster infrastructure. Though small platforms demand low power, general-purpose AI processors tend to be power hungry, through a decentralized/distributed architecture and co-design of the AI algorithms and AI hardware, significant reductions in power may be achieved. By iteratively pruning the neural net, training the quantization to function as a ternary number system, and by tailoring the algorithm to the hardware and the hardware to the algorithm, an AI/ML solution can be developed consistent with this fractionated application. With such a fractionation-specific AI processor, this AI/ML capability would learn how to increase the endurance of the cluster while improving all aspects of mission performance.

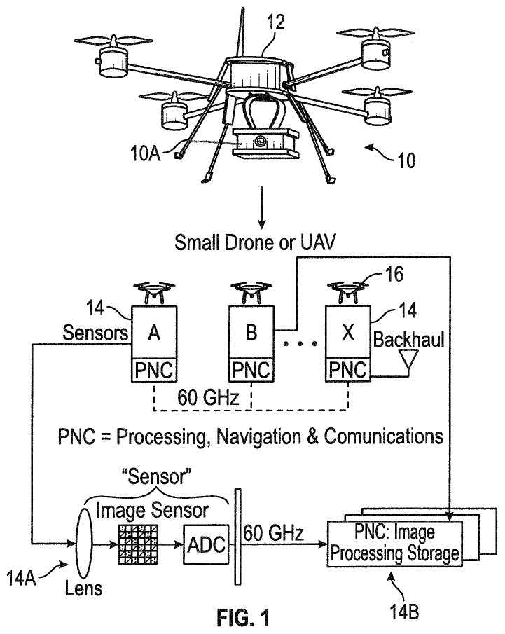

Referring to FIG. 1, in many remote sensing applications, one or more sensor systems may need to be incorporated into a sensor/payload 10. The more sensor systems that may be needed, the larger the sensor/payload 10 may become. Large sensor/payloads 10 generally require large system drones 12 in order to transport the sensor/payload 10. Unfortunately, large system drones 12 are costly, more easily seen and thus not covert, not as maneuverable as smaller drones, and less flexible as the payload is generally fixed and not easily modifiable.

In order to reduce the size of the sensor/payload 10, industries are attempting to keep reducing the size of sensors to create payloads that are small and lightweight enough to be carried by small UAV's and drones. Unfortunately, at times the sensor is governed by the physics of the sensing problem setting fundamental limits. Thus, the reduction of size of the sensors may be limited.

Instead of trying to reduce the size of the sensor/payload 10, the present invention fractionates the sensor/payload 10 into a connected plurality/cluster of small components/platforms 14 (hereinafter platforms 14) which may still function as the single sensor/platform 10. The plurality of platforms 14 may be able to cooperate and distribute operations. Cooperation may be where one of the platforms 14 perform a function for another, while distribution may be where a task is divided across the plurality of platforms 14. Thus, common functions such as processing and storage may be distributed and shared across the plurality of platforms 14 reducing the ‘sensor’ to the sensing function alone.

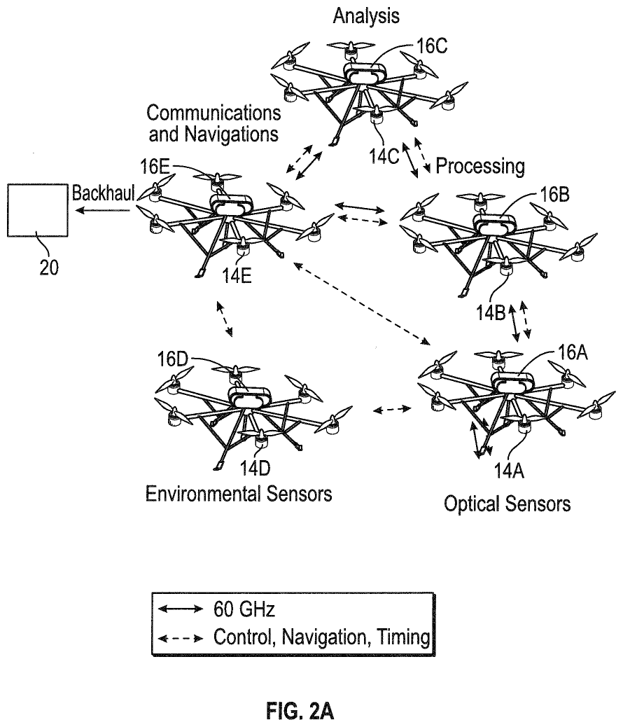

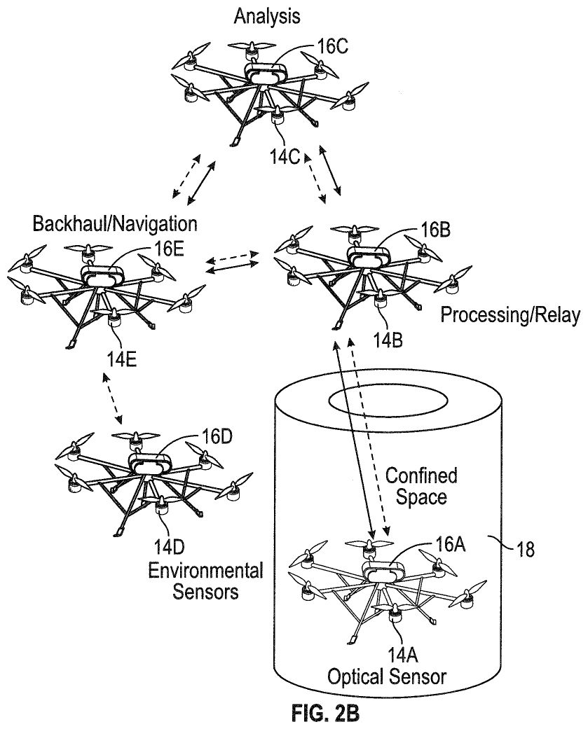

Referring to FIGS. 1-2B, one embodiment of the fractionization of the sensor/payload 10 may be seen. The sensor/payload 10 may be fractionated across lines of functionality. The sensor/payload 10 may be fractionated into a plurality of smaller platforms 14. Each platform 14 may be used to perform a specified task. For example, the platform 14 may be a sensor for recording a desired property, a processor for compressing and/or analyzing data or similar payloads. In accordance with one embodiment, the sensor may be an optical sensor, image sensor, zoom camera, infrared (IR) thermal imaging camera, laser range finder, or similar type of sensor/monitoring device. The above is given as examples and should not be seen in a limiting manner. Each of the platforms 14 may be integrated into a small UAV 16 wherein the plurality of platforms 14 may work together to have the same functionality of the sensor/payload 10.

In the present embodiment, the sensor/payload 10 may be an optical sensor 10A. However, this is shown as one example and should not be seen in a limiting manner. The sensor/payload 10 may be any type of sensor or payload without departing from the scope of the present embodiment. In general, an optical sensor may have lenses, image sensor, image processing unit, storage, and similar functional components. Thus, the optical sensor 10A may be fractionated into a plurality of platforms 14 wherein each of the platforms 14 may have one of the components. For example, the optical sensor 10A may be fractionated into a data monitoring and recording sensor 14A, a data processing component 14B, a function/analysis component 14C, an environmental sensor 14D and a communication component 14E. Each of these platforms 14 may be mounted on a corresponding small UAV 16A-16E respectively. It should be noted that while the sensor/payload, in this embodiment the optical sensor 10A, may be shown to be fractionated into 5 different smaller platforms 14, this is shown as an example. The optical sensor 10A maybe fractionated into any number of different smaller platforms 14.

The use of smaller UAVs 16A-16E may allow one or more of the smaller UAVs 16A-16E to move in and out of confined spaces 18 where the drone 12 may not be able to enter. In the present embodiment the data monitoring and recording sensor 14A (the lens and optics in the present embodiment) may be integrated into a smaller more maneuverable UAV 16A. The UAV 16A may be more capable to move in and out of confined space 18 than the drone 12. For example, in a cave, nuclear reactor, or similar small confined spaces, a single larger drone 12 may be incompatible with the confined nature of the environment. However, the monitoring and recording sensor 14A, which may be mounted on the smaller UAV 16A, may be able to fly into the confined space 18 and record the desired data.

The monitoring and recording sensor 14A may then digitize this data and transmit the digitized data to the data processing component 14B coupled to the UAV 16B. The UAV 16B may be located within wireless communication of the UAV 16A. As shown in FIG. 2B, the UAV 16B may be located outside of the confined space 18 where the UAV 16A may be located. In accordance with one embodiment, the monitoring and recording sensor 14A may transmit the digitized data to the data processing component 14B via a 60 GHz wireless link. Transmission of data in this rage may allow for multiple full rate video to be transmitted to the data processing component 14B. In addition to the high-data rates that can be accomplished in this spectrum, energy propagation in the 60 GHz band has unique characteristics that make possible many other benefits such as excellent immunity to interference, high security, and frequency re-use.

The data processing component 14B may process the data transmitted and received. The data processing component 14B may convert the data to machine-readable form, format or transform the data such as compression, or other processing functions.

The data processed by the data processing component 14B may then be transmitted to a function/analysis component 14C coupled to the UAV 16C. The UAV 16C may be located so as to be within wireless communication of the UAV 16B. In accordance with one embodiment, the data processing component 14B may transmit the processed data to the function/analysis component 14C via a 60 GHz wireless link. The function/analysis component 14C may perform any functions/analysis of the data. For example, in the present embodiment, the data processing component 14B may analysis the video data to determine what the object being monitor is, changes to the object being monitor, or other types of analysis of the video data.

The fractionated system may include an environmental sensor 14D and a communication component 14E coupled to UAV 16D and UAV 16E respectively. The environmental sensors 14D may be used to provide various types of information: location, position, movement and contextual elements. Thus, the environmental sensors 14D may be used to control navigational information to the plurality of UAVs 16A-16E. The communication component 14E may be used to provide a communication link. The communication component 14E may provide a connection from the plurality of UAVs 16A-16E (i.e., smaller sub-network) to a core network 20.

The sensor/payload 10, in the present embodiment, the optical sensor 10A, may be fractionated into five different smaller payloads 14A-14E each coupled to a separate UAVs 16A-16E, respectively. The fractionization of the sensor/payload 10 may provide a less expensive system as the smaller UAVs 16A-16E may be less expensive than the drone 12, as in general, cost of the drone 12 does not scale as the size increases. Thus, a plurality of smaller UAVs 16A-16E may generally be significantly less expensive than the larger drone 12. The fractionization of the sensor/payload 10 may further provide a more covert system as the smaller UAVs 16A-16E may be less likely to be seen and may be more maneuverable than the larger drone 12. The fractionization of the sensor/payload 10 may further may further be more flexible than the sensor/payload 10, as one may be able to swap out the monitoring and recording sensor 14A with a different monitoring and recording sensor 14A based as needed.

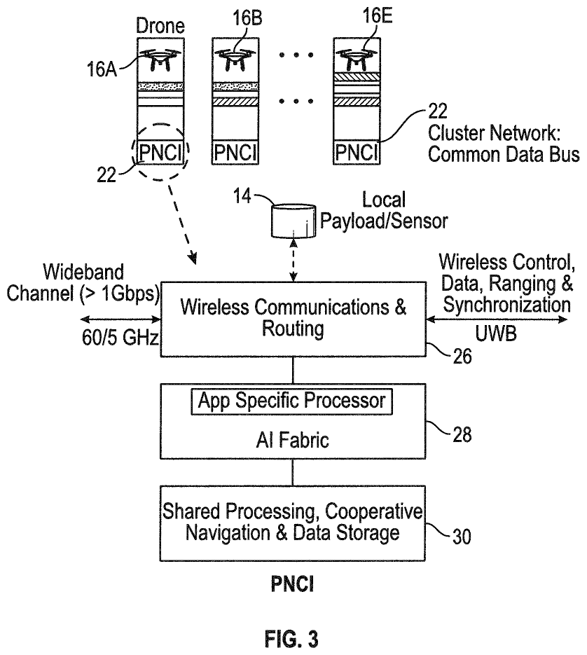

In order for the plurality of platforms 14 to work together to have the same functionality of the sensor/payload 10, each of the smaller platforms 14 and corresponding UAVs 16A-16E should be tied together by an infrastructure. As shown in FIG. 3, each of the plurality of small platforms 14 may be coupled to a processing, networking, communication interface (PNCI) 22. The PNCI 22 coupled to each of the platforms 14 may communicate with one another as shown in FIGS. 2A-2B. The interconnection of the PNCIs 22 may form a cluster network with a common data bus.

Each PNCI 22 is coupled to a corresponding platform 14. Each PNCI 22 may have a wireless communicating and routing unit 26, an artificial intelligence/machine learning unit 28 and a shared processing and storage unit 30.

The wireless communicating and routing unit 26 may be used to coordinate the wireless communication of the data to other platforms 14. The wireless communicating and routing unit 26 may also be used for location discovery, ranging and synchronization of data between the smaller platforms 14. In accordance with one embodiment, the communicating and routing unit 26 may be a multi-mode communicating and routing unit 26. Multi-mode wireless communication may allow the communicating and routing unit 26 to use multiple communication channels. For example, the communicating and routing unit 26 may have one communication link for transmitting and receiving data intensive signals and another communication link for transmitting and receiving data signals that may be related to network management. The communication link for transmitting and receiving data intensive signals may be a dynamic bandwidth allocation link wherein the bandwidth based on service type (video, data, etc.)

In accordance with one embodiment, the communicating and routing unit 26 may have a wideband channel, for example greater than 1 Gbps to transmit/receive high bandwidth data between platforms 14 and a UWB channel for transmitting/receiving network management signals between platforms 14 such as wireless control signals, data signals, ranging signals, synchronization signals and other similar signals. In accordance with one embodiment, the wideband channel may use dual bands. For example, the data may be transmitted and received at 5 and 60 GHz. Transmission of data in this rage may allow for multiple full rate video to be transmitted to the data processing component 14B. In addition to the high-data rates that can be accomplished in this spectrum, energy propagation in the 60 GHz band has unique characteristics that make possible many other benefits such as excellent immunity to interference, high security, and frequency re-use. The UWB channel may be used to transmit less data intensive signals. UWB is a radio technology that can use a very low energy level for short-range, high-bandwidth communications over a large portion of the radio spectrum. The communicating and routing unit 26 may use a UAW nano transmitter. The UAW nano transmitter may send data in pulse sequences every few seconds.

Each PNCI 22 may have an artificial intelligence (AI)/machine learning unit (ML) 28. The AI/ML unit 28 may allow for resource optimization, cluster flying, and mission dependent functions such as rules-based distribution of tasks. The AI/ML functionality may be decentralized and distributed between all of the AI/ML units 28 forming the cluster of small platforms 14. Each small platform 14, and thus each small UAV 16, may function as a host, capable of executing its part. Each AI/ML unit 28 may contain a controller, which has one or more algorithms to manage resources, control cluster formation, and other functionality. As may be seen in FIG. 2A-2B, the cluster of small platforms 14, and thus the AI/ML unit 28 of each of the small platforms 14 may be interconnected to form a neural network which may be distributed and balanced. The different algorithms in each AI/ML unit 28 of each of the small platforms 14 function to recognize underlying relationships in the sets of data received. The neural network formed can adapt to changing input so that the neural network generates the best possible result without needing to redesign the output criteria.

Each PNCI 22 may have a shared processing and storage unit 30. The shared processing and storage unit 30 may allow the processing of data to be decentralized and distributed between all of the shared processing and storage units 30 forming the cluster of small platforms 14. Thus, in the present embodiment, while one of the smaller platforms 14 was indicated to be the data processing component 14B, the processing of data recorded by the monitoring and recording sensor 14A may be distributed to the data processing component 14B as well as other small platforms 14.

The cluster of small platforms 14, and thus the PNCI 22 of each of the small platforms 14 may be interconnected and use a publish-subscribe (pub/sub) architecture for shared processing and cooperative operation. A pub/sub architecture is a messaging pattern where publishers push messages to subscribers. In this type of architecture, pub/sub messaging provides instant event notifications for distributed applications, especially those that are decoupled into smaller, independent building blocks.

In a pub/sub architecture, each small platform 14 may form a node. Protocols may be established for each small platform 14 (i.e., node) to publish capabilities and resources. Each small platform 14 may subscribe to obtain sensor data and processing support. Pub-sub architecture enables dynamic, distributed processing across the entire cluster of small platforms 14. This may allow the cluster of small UAVs 16 to cluster-fly with cooperative navigation.

The fractionization of the sensor/payload 10 into a connected plurality/cluster of small platforms 14 may allow for a modular plug-n-play type of system. Different small platforms 14 may be added and/or removed to allow for the diversification of missions. This may allow for the insertion of emerging sensor technology over life of the platform. While different small platforms 14 may be added and/or removed, any new small platforms 14 to be added may require authorization prior to joining.

The foregoing description is illustrative of particular embodiments of the application, but is not meant to be a limitation upon the practice thereof. The following claims, including all equivalents thereof, are intended to define the scope of the application.

What is claimed is:

1. A payload transport system comprising:
a plurality of unmanned aerial vehicles (UAVs);
wherein the payload is fractionated into a plurality of components wherein each of the plurality of components is coupled to one of the plurality of UAVs, each of the plurality of components wirelessly in communication to function as the payload.

2. The payload transport system of claim 1, wherein the plurality of components comprises:
a data monitoring and recording sensor;
a data processing unit processing data recorded by the data monitoring and recording sensor; and
a communication component connecting the plurality of UAVs to a core network.

3. The payload transport system of claim 2, wherein the plurality of components comprises a function/analysis component analyzing the data recorded by the data monitoring and recording sensor.

4. The payload transport system of claim 2, wherein the plurality of components comprises an environmental sensor providing navigation data to the plurality of UAVs.

5. The payload transport system of claim 1, wherein each of the plurality of components comprises a processing, networking, communication interface (PNCI) wirelessly interconnecting the plurality of components to form a cluster network.

6. The payload transport system of claim 1, wherein each of the plurality of components comprises a processing, networking, communication interface (PNCI) wirelessly interconnecting the plurality of components to form a cluster network with a common data bus.

7. The payload transport system of claim 5, wherein each PNCI comprises:
a wireless communicating and routing unit transmitting and receiving data signals between the plurality of components; and
an artificial intelligence/machine learning unit.

8. The payload transport system, of claim 7, wherein each of PNCI comprises a processing and storage unit.

9. The payload transport system, of claim 7, wherein the wireless communicating and routing unit is a multi-mode wireless communication having a first communication link for transmitting and receiving high bandwidth data signals and a second communication link for transmitting and receiving data signals for network management.

10. The payload transport system, of claim 9, wherein the second communication link transmits and receives location discovery, ranging and synchronization data.

11. The payload transport system, of claim 7, wherein the wireless communicating and routing unit is a multi-mode wireless communication having a wideband channel greater than 1 Gbps to transmit/receive high bandwidth data of the local payload and a UWB channel for transmitting/receiving network management signal.

12. The payload transport system, of claim 11, wherein the wideband channel is dual bands.

13. The payload transport system, of claim 7, wherein artificial intelligence/machine learning functionality is decentralized and distributed between a plurality of the artificial intelligence/machine learning units.

14. The payload transport system, of claim 8, wherein processing of data is decentralized and distributed between all of the processing and storage units.

15. A payload transport system comprising:
a plurality of unmanned aerial vehicles (UAVs);
wherein the payload is fractionated into a plurality of components wherein each of the plurality of components is coupled to one of the plurality of UAVs, each of the plurality of components is wirelessly in communication with one another to form a network and to function as the payload, wherein tasks of at least one of the components is decentralized and distributed between multiple components;
wherein each of the plurality of components comprises a processing, networking, communication interface (PNCI) wirelessly interconnecting the plurality of components to form a cluster network, wherein each PNCI comprises:
a wireless communicating and routing unit transmitting and receiving data signals between the plurality of components;
an artificial intelligence/machine learning unit; and
a processing and storage unit.

16. The payload transport system of claim 15, wherein the plurality of components comprises:
a data monitoring and recording sensor;
a data processing unit processing data recorded by the data monitoring and recording sensor; and
a communication component connecting the plurality of UAVs to a core network.

17. The payload transport system of claim 16, wherein the plurality of components comprises a function/analysis component analyzing the data recorded by the data monitoring and recording sensor.

18. The payload transport system of claim 17, wherein the plurality of components comprises an environmental sensor providing navigation data to the plurality of UAVs.

19. The payload transport system, of claim 16, wherein the wireless communicating and routing unit is a multi-mode wireless communication having a first communication link for transmitting and receiving high bandwidth data signals and a second communication link for transmitting and receiving data signals for network management.

20. The payload transport system, of claim 16, wherein the wireless communicating and routing unit is a multi-mode wireless communication having a wideband channel greater than 1 Gbps to transmit/receive high bandwidth data of the local payload and a UWB channel for transmitting/receiving network management signal.
